(19) United States
(12) Patent Application Publication
(10) Pub. No.: US 2025/0085692 A1
(43) Pub. Date: Mar. 13, 2025

(54) SYSTEM AND METHOD FOR PRODUCING A MODULAR, MASS-PRODUCIBLE SPACECRAFT ARCHITECTURE

(71) Applicant: Copernicus Space Corporation, Billerica, MA (US)

(72) Inventors: Michael Snyder, Jacksonville, FL (US); William White, Naples, FL (US); Dustin Larsen, Jacksonville, FL (US)

(21) Appl. No.: 18/830,564

(22) Filed: Sep. 10, 2024

Related U.S. Application Data
(60) Provisional application No. 63/537,548, filed on Sep. 10, 2023.

(51) Int. Cl. G05B 19/4099

(52) U.S. Cl. CPC G05B 19/4099; G05B 2219/49023

(57) ABSTRACT

A system for producing a modular bus architecture for use in a satellite includes a processor configured to determine a support structure arrangement selected from predefined support structure components that are configurable to form various modular bus architectures for use in outer space. The support structure is configurable in a plurality of arrangements based on an intended space-based mission as determined by the processor. A plurality of the predefined components that are to be included with the support structure are further determined by the processor based on parameters selected for the intended mission. A method for producing the modular bus architecture includes determining a build of the modular bus architecture based on pre-set parameters, arranging the support structure selected from the predefined support structure components, and selecting components that are to be included with the support structure as further determined by the processor.

### BACKGROUND

Spacecraft are vehicles that are designed to fly and operate in outer space. Even when multiple, identical spacecraft are being built for the same intended purpose, during the build process, each usually still end up being built slightly different than the others. This results because when testing the spacecraft prior to launching it to orbit, if the spacecraft does not meet a particular design parameter or objective, whereas the other spacecraft may meet the particular design parameter or objective, that one that does not is reconfigured to meet the design parameter or objective. Therefore, even though each similarly built spacecraft may look the same superficially, there may still be seen or unseen differences when compared to others.

A small satellite, miniaturized satellite, or smallsat is a satellite of low mass and size. Smallsats are typically built small to reduce the large economic cost associated with the cost of launch vehicles and the costs associated with construction. Smallsats when used in number may be more useful than fewer, larger satellites, depending on the satellites' purpose.

Manufacturers and users of satellites where more than a single version of the satellite is needed would benefit from a method to autonomously create repeatable manufactured satellites based on user input where configuring each satellite provides confirmation a configuration will be successful of the intended mission, the cost to build and the timeline it will take to build, as non-limiting examples of information provided.

### SUMMARY

Embodiments relate to a system and method for creating a satellite where the same satellite can be reproduced with the same configuration based on a use of modular components that can be configured for multiple satellite architecture configurations to provide for lower build cost, sooner production time while offering a plurality of performance envelopes. The system comprises a processor with at least one of: at least one preprogrammed algorithm, at least one machine learning algorithm, or an artificial intelligence (“AI”) subsystem, configurable to determine a build of the modular bus architecture for use in a satellite that may be part of a swarm of same satellites based on pre-set parameters. More specifically a “swarm” is when a plurality of satellites operates in concert to perform a defined mission where the satellites make decisions, typically independently, based on shared information.

The processor is used to determine a support structure arrangement selected from predefined support structure components that are configurable to form various modular bus architectures for use in outer space where the support structure is configurable in a plurality of arrangements determined by an intended space-based mission by the processor. The processor is further used to determine components that are included with the support structure as determined by the processor based on parameters selected for an intended mission.

The method comprises determining a build of a modular bus architecture for use in a satellite that is part of a swarm of same satellites based on pre-set parameters that are provided to an artificial intelligence (“AI”) subsystem, or at least one preprogrammed or machine learning algorithm, that is part of a processor, further comprising arranging a support structure selected from predefined support structure components that are configurable to form various modular bus architectures for use in outer space where the support structure is configurable in a plurality of arrangements as determined by an intended space based mission by the processor and selecting components that are included with the support structure as determined by the AI subsystem, or at least one preprogrammed or machine learning algorithm, based on parameters selected for an intended mission. The subsequent satellites that are part of the swarm comprise the same parameters.

A satellite that is part of a swarm of satellites is also provided. The satellite comprising a support structure formed from a set of predefined support structures that are configurable to form the support structure for an intended mission of the satellite, and a plurality of components included with the support structure wherein the plurality of components is selected by a processor having an artificial intelligence subsystem, or at least one preprogrammed or machine learning algorithm. The resulting satellite build is repeatable so that each satellite in the swarm is identical as established by the AI subsystem or preprogrammed or machine learning algorithm(s).

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 shows a plurality of unassembled components of a base structure for a modular bus architecture;

FIG. 2 shows a plurality of various framework structures that can be made from the base structure components shown in FIG. 1;

FIG. 3 shows a plurality of exemplary embodiments of finished buses based on the embodiments shown in FIG. 2;

FIG. 4 shows an exploded view of components of the modular bus architecture;

FIG. 5 shows additional various embodiments of how the modular bus architecture is scalable when using the same components;

FIG. 6 shows additional various embodiments of how the modular bus architecture is scalable when using the same components;

FIG. 7 shows exemplary process flow that is used to establish a modular bus architecture;

FIG. 8 shows additional exemplary process flow that is used to establish a modular bus architecture;

FIG. 9 shows yet more exemplary process flow that is used to establish a modular bus architecture;

FIG. 10 shows an embodiment of an on-board computer architecture;

FIG. 11A shows an embodiment of a flight computer;

FIG. 11B shows an embodiment of a flight computer;

FIG. 12 shows alternate configuration examples of a full architecture;

FIG. 13 shows an exemplary embodiment of a core architecture;

FIG. 14 shows a block diagram of an exemplary computer system, device, or computing functionality.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Embodiments disclosed herein provide for a system and method for assembling spacecraft out of components. Starting at the structure, a defined number of unique parts may create a structural support for a wide range of assembled sizes through use of common interfaces connecting the components. All subsystems may be scalable through either the edition of the same components or the direct swapping for more capable ones where all components may use the same interface locations and mounting patterns.

System redundancy may be created by stacking systems, components or architecture through pre-planned mechanisms and computerized processes which may provide for various risk reduction and lifetime profiles to be created. As further disclosed herein, any resulting architecture may be completely configurable in a digital model that identifies the manufacturing instructions and steps in a print to manufacture paradigm.

The architecture disclosed herein may include modular components to allow for lower cost production of large numbers of satellites. This includes a focus on sourcing from industrial and commercially available parts and assemblies. The design and manufacturing may be performed utilizing digital first activity which may utilizing systems engineering and digital twins (software and a processor) to maximize efficiency and understanding of the entire value chain associated with the architecture. Manufacturing may take advantage of vertical integration to simplify supply chains with standardized components that allow for high throughput manufacturing. Though non-limiting, subsystems may include a structure, an electrical power system (EPS), an On-Board Computer (OBC), a communication subsystem, thermal systems, Attitude Determination and Control Systems (ADACS), and a propulsion.

Furthermore, the embodiments may be on exploration swarm design reference missions and industry-provided design reference missions to assist with developing an artificial intelligence (“AI”) subsystem to control a swarm of smallsats that are function together where the artificial intelligence subsystem provides for a predictable behavior of the swarm in operation.

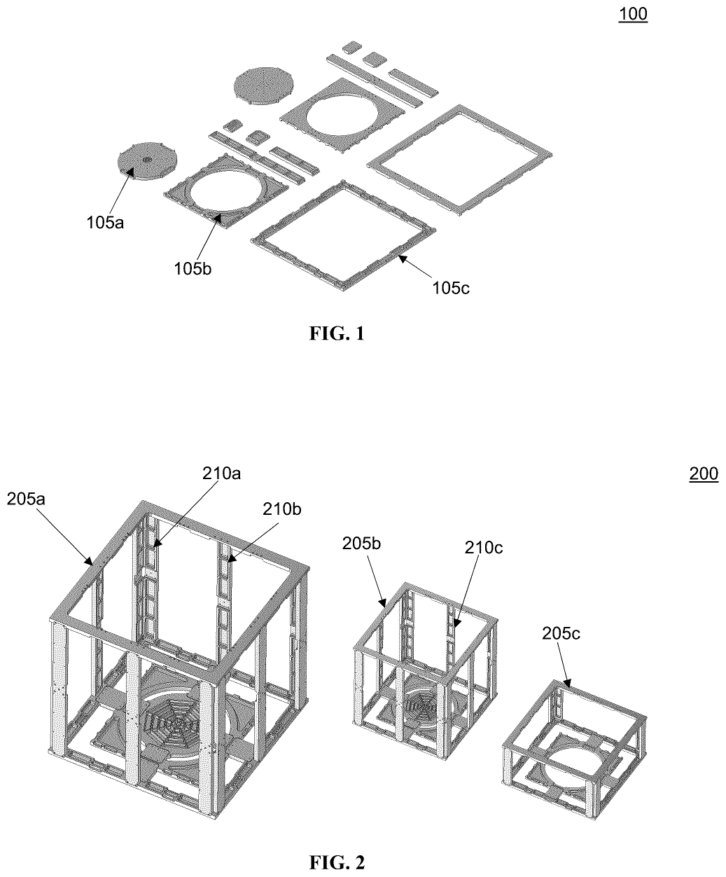

FIG. 1 shows a plurality of unassembled components 100 of a base structure for a modular bus architecture. A base number of structural components 105 (labeled only as structural components 105a-c in FIG. 1) are envisioned. In some implementations, at least a portion of the structural components are electrical, such as, for example and not limitation, wires or photovoltaic cells. The structure is to be provided to incorporate all of the assemblies or subsystems needed for an intended operation or mission. Thus, the structure arrangement may factor any intended payload attachments and the structure components 105 may consider commercially available components 105 as well as manufacturing the structural components 105 utilizing any known manufacturing process, including any automated manufacturing process and/or additive manufacturing process.

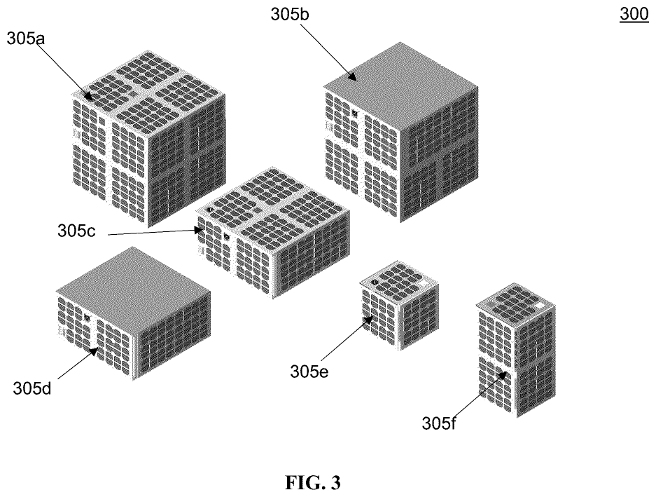

FIG. 2 shows a plurality of various framework structures 200 that can be made from the base structure components shown in FIG. 1. As shown. The components may be arranged to build a specific structural framework 205a-c. The various sizes shown in FIG. 2 may be based on either have various structural components or having components such as vertical components 210 (labeled only as 210a-c in FIG. 2, for clarity) that can be separated into multiple parts, as is visible in FIG. 2.

FIG. 3 shows a plurality of exemplary embodiments 300 of finished buses 305a-f based on the embodiments shown in FIG. 2. More specifically, FIG. 3 shows a completed architecture for each bus 305a-f, in a stowed configuration. In several of the embodiments shown, the outer surface may be solar arrays.

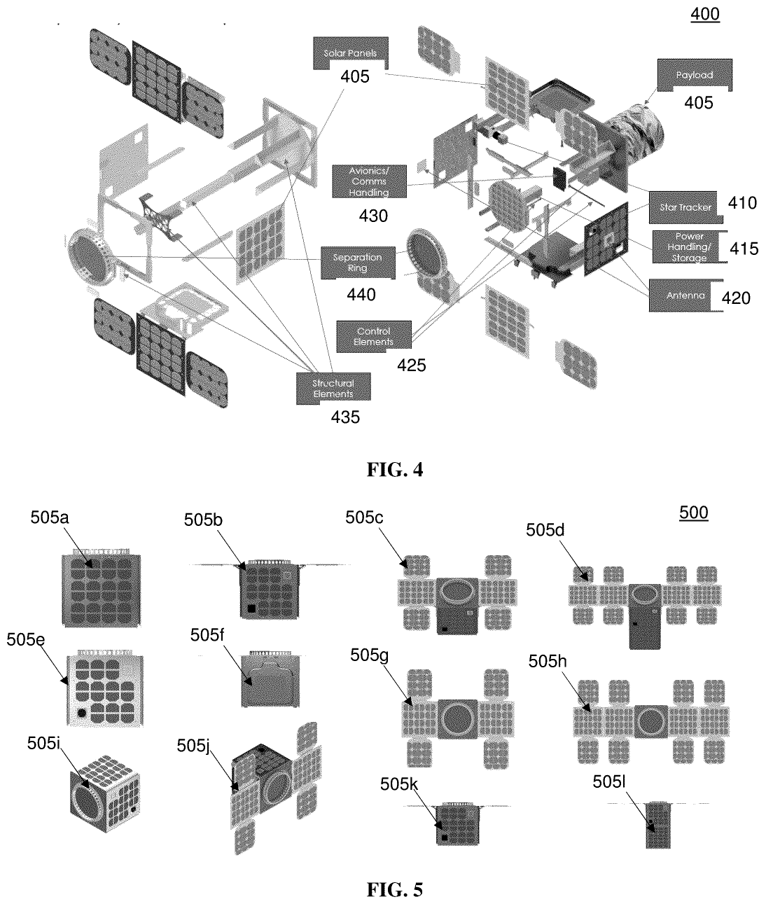

FIG. 4 shows an exploded view of components of the modular bus architecture 400. As shown, though not limited, the architecture 400 may comprise a payload 405, a star tracker 410, a power handling/power storage subsystem 415, an antenna 420, control elements 425, and an avionics/communication subsystem 430. Structural elements 435, including those discussed above, are included as well as solar panels. A separation ring 440 may also be provided which may be used to separate the architecture 400 from a transport system or another architecture which may be part of the same swarm.

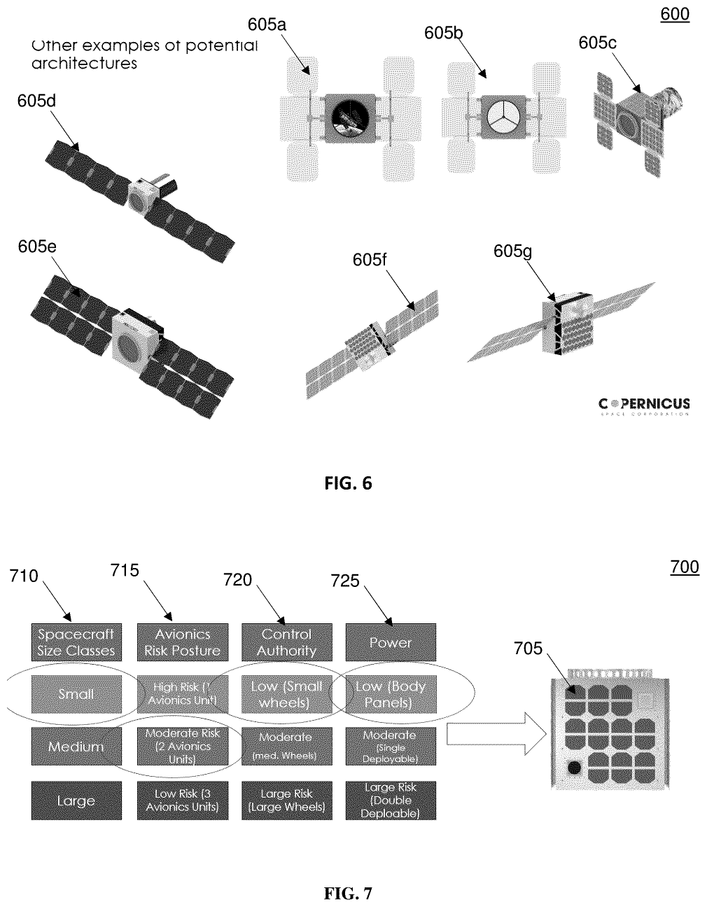

FIGS. 5 and 6 each shows a plurality of embodiments 500, 600 of how the modular bus architecture 505a-1, 605a-g is scalable when using the same components. As shown, when deployed, the architecture deployed configuration 505a-1, 605a-g is not limited.

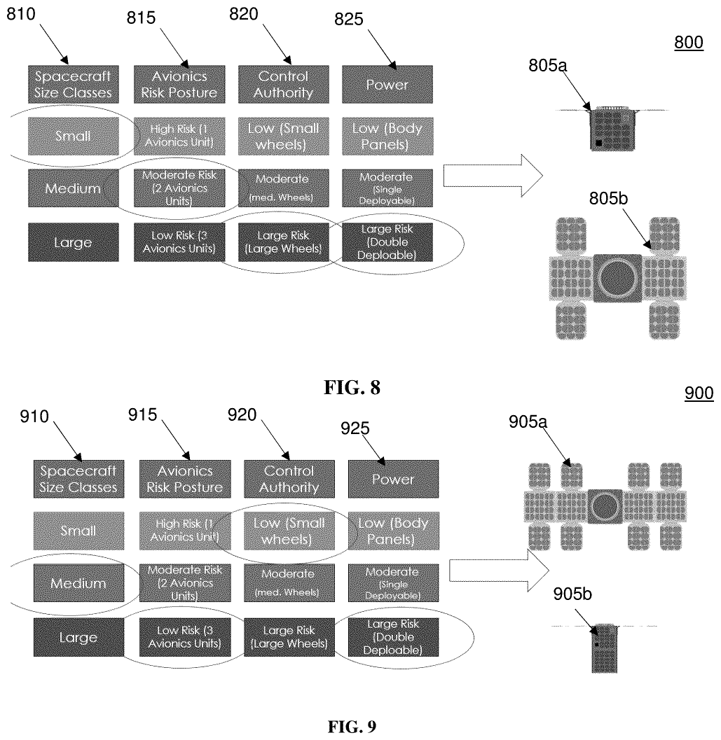

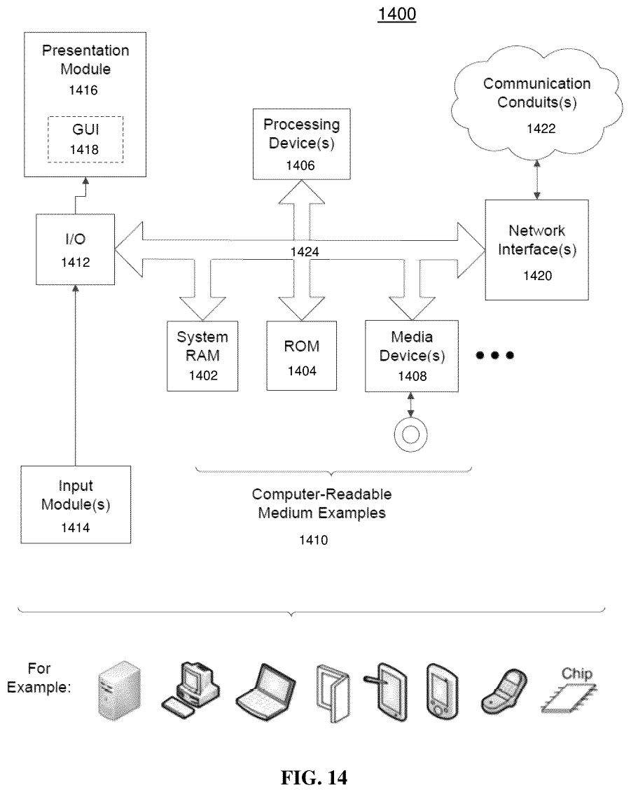

FIGS. 7, 8 and 9 show exemplary process flows 700, 800, 900 that may be used to establish a modular bus architecture 705, 805, 905. The process 700, 800, 900 may be performed with a computing system, such as shown in FIG. 14. Certain variables may be utilized that when selected, allow the process 700, 800, 900 to select the configuration of the architecture 705, 805, 905 and to build the architecture 705, 805, 905 based on the selected parameters. In an embodiment, an artificial intelligence (“AI”) module, that provides for predictable behavior during creation, may be included with the processor that assists in optimizing the final architecture 705, 805a-b, 905a-b. As further shown, non-limiting parameters that may be used to determine the configuration include spacecraft size/class 710, 810, 910, avionics risk posture 715, 815, 915, control authority 720, 820, 920, and power 725, 825, 925, where options are available under each category. Based on the options selected, as further illustrated in each of FIGS. 7, 8 and 9, a different architecture configuration 705, 805a-b, 905a-b is constructed based at least partially on whether there are deployable components or not, as also determined by the selections made.

As shown, the non-limiting options under spacecraft size/class 710, 810, 910 may include small, medium or large, where each size has a reset weight and geometric definition associated with the selection. Under avionics risk posture 715, 815, 915, non-limiting options may include high risk, moderate risk, and low risk, where the risk level may determine the number of avionic units that are included. For control authority 720, 820, 920, again the levels may be low, moderate, and large, where the size of wheels used is determined based on the level selected. Likewise, power level 725, 825, 925 may also have such levels as low, moderate, and large, where the type of solar arrays and/or batteries (such as, for example and not limitation, body panels, single deployable, or double deployable) included are determined based on the level identified.

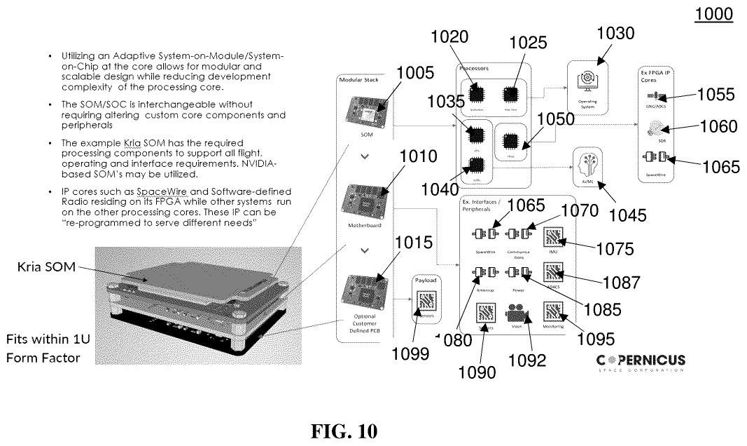

FIG. 10 shows an embodiment of an on-board computer architecture 1000. The computer architecture 1000 may utilize an adaptive system-on-module/system-on-chip (“SOM/SOC”) 1005 to provide for a modular and scalable design of the computer architecture 1000 while also reducing development complexity of the processing core. The SOM/SOC 1005 may be interchangeable without requiring altering custom core components and peripherals of the overall architecture 1000. As a non-limiting example of a SOM/SOC 1005 that may be used, a Kria™ SOM 1005 may be utilized as it has processing components that may support flight, operating and interface requirements. Another non-limiting possibility is a NVIDIA™-based SOM. Other prior art components such as a spacecraft communication network known as Space Wire™ or a software-defined radio residing on a field programmable gate array (“FPGA”) within the computer architecture while other computing subsystems running on the other processing cores are possible. These subsystems can be “re-programmed” to serve different needs required for the mission.

In some implementations, the on-board computer architecture 1000 may comprise a modular stack that includes the SOM/SOC 1005, a motherboard 1010, and an optional customer defined printed circuit board (PCB) 1015. In some aspects, the SOM/SOC 1005 may comprise at least one of a plurality of potential processors, including but not limited to an application processor 1020 and a real time processor 1025, which may be configured to facilitate an operating system 1030; a graphics processing unit (GPU) 1035 and an artificial intelligence (AI)/machine learning (ML) processor or infrastructure 1040, which may be used to facilitate AI/ML capabilities 1045; and an FPGA 1050, which may be configured to facilitate GNC/ADCS functionality 1055, SDR functionality 1060, and Space Wire™ functionality 1065.

In some aspects, the motherboard 1010 may be configured to support implementation of one or more interfaces or peripherals, such as, by way of example and not limitation, Space Wire™ functionality 1065, communications 1070, IMU 1075, antennas 1080, power 1085, ADACS 1087, sensors 1090, vision 1092 (such as, for example and not limitation, via camera(s)), and monitoring 1095. In some non-limiting exemplary embodiments, the PCB 1015 may be configured to facilitate utilization of one or more payload sensors 1099.

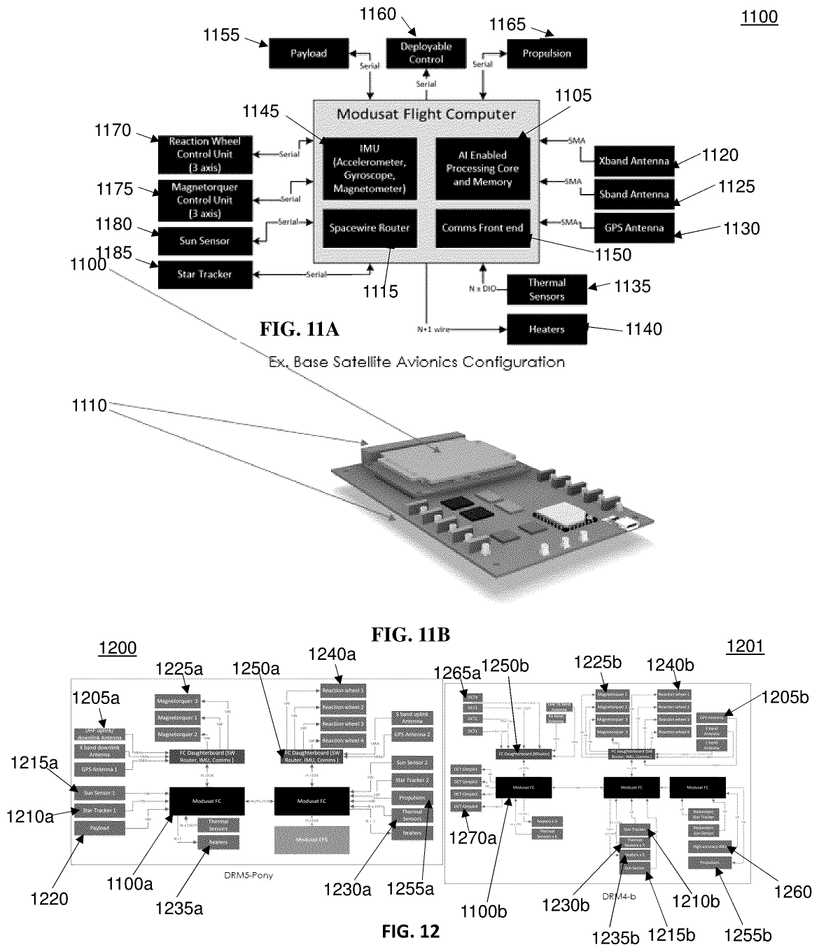

FIGS. 11A and 11B show an embodiment of a flight computer 1100. As shown, an AI enabled SOC/SOM processing core 1105 is provided. As disclosed herein, the processing core 1105 provides for predictable behavior when utilized. An FPGA for On-orbit programmability is provided. An AI accelerator/GPU is also included. A radio subsystem that is defined or enabled via computer code (software) is provided. A router 1115, such as, but not limited to a SpaceWire™ Router may be included. Furthermore, one or more of a plurality of interfaces 1110 are provided. By way of example and not limitation, software and/or hardware and/or HDL is provided that has configurable peripheral interfaces for minimal or no physical plug changes and/or interface converting hardware/software being required is included. Antennas interfaces, such as but not limited to more than one, with integrated communications (at least S-band 1125 and/or X-band Standard 1120) are provided that may interface with a front end communications subsystem or module 1150. Interfaces for thermal sensors 1135 and heaters 1140 are disclosed. An integrated 9-axis inertial measurement unit (“IMU”) 1145 with global positioning system (“GPS”) antenna 1130 interface may also be provided. Though a 9-axis IMU 1145 is disclosed, the number of axes is not limited. An expandable and/or stackable computer buses, which may utilize PC104 standards, such as, but not limited or a serial-like interface. In some aspects, a variety of additional interfaces 1110 may also be provided for, by way of example and not limitation, one or more of: a payload subsystem or module 1155, a deployable control subsystem or module 1160, a propulsion subsystem or module 1165, a reaction wheel control unit 1170, a magnetorquer control unit 1170, one or more sun sensors 1175, or one or more star trackers 1180.

Redundancy can be achieved by having multiple flight computers 1100 within a single system. Multiple computers 1100 within the architecture may be used for different on board tasks but may also be reconfigured in flight as needed, such as, but not limited to if the architecture malfunctions and needs to be recovered for continued use. The multiple computers 1100 may be active or dormant and be brought on-line/off-line as needed. Additional redundancy may also be achieved by dividing a single SOC/SOM 1005 into multiple redundant cores. Multiple computers 1100 may actively monitor for data or compare data for errors and/or abnormalities and subsequently reconfigure as necessary to continue the intended mission.

FIG. 12 shows alternate configuration examples of a full architecture 1200, 1201. As shown, various components may be included in addition to one or more flight computers 1100 (labeled only as flight computers 1100a-b in FIG. 12, for clarity), such as, but not limited to various antennae 1205 (labeled only as antennae 1205a-b in FIG. 12, for clarity), star trackers 1210 (labeled only as star trackers 1210a-b in FIG. 12, for clarity), sun sensors 1215 (labeled only as sun sensors 1215a-b in FIG. 12, for clarity), payloads 1220, magnetorquers 1225 (labeled only as magnetorquers 1225a-b in FIG. 12, for clarity), thermal sensors 1230 (labeled only as thermal sensors 1230a-b in FIG. 12, for clarity), heaters 1235 (labeled only as heaters 1235a-b in FIG. 12, for clarity), reaction wheels 1240 (labeled only as reaction wheels 1240a-b in FIG. 12, for clarity), heat interface units, support motherboards 1250 (daughterboards) (labeled only as support motherboards 1250a-b in FIG. 12, for clarity), propulsion subsystems or modules 1255 (labeled only as propulsion subsystems or modules 1255a-b in FIG. 12, for clarity), IMUs 1260 October units or modules/subsystems 1265 (labeled only as OCT unit or module/subsystem 1265a in FIG. 12, for clarity), OCT gimples 1270 (labeled only as OCT gimple 1270a in FIG. 12, for clarity), etc.

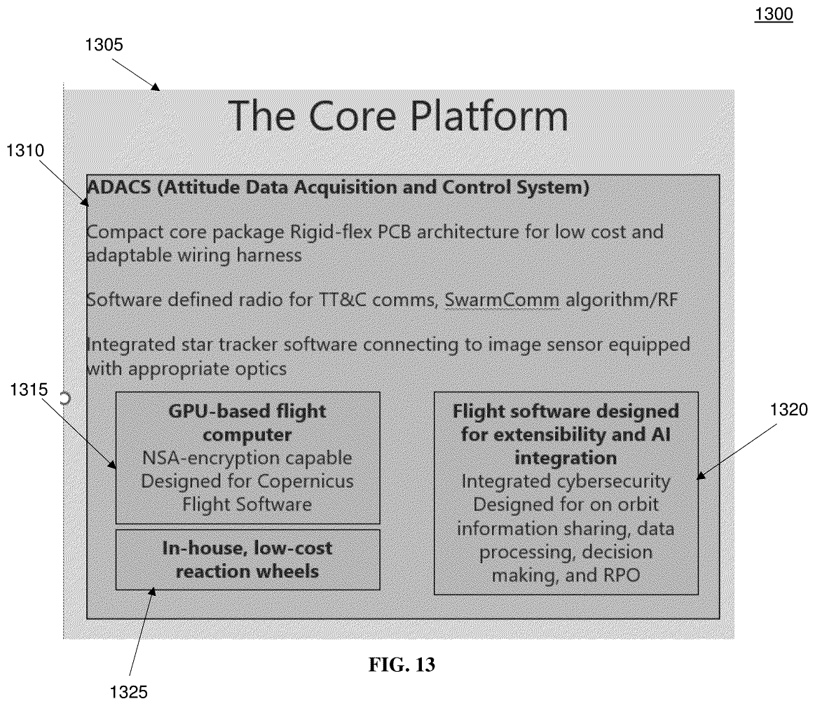

FIG. 13 shows an exemplary embodiment of a core architecture 1300. The architecture 1300 may be used to create a compact flexible smallsat architecture with an adaptable wiring harness. As shown, the architecture 1300 may be a core platform 1305 with an attitude data acquisition and control subsystem 1310. This subsystem 1310 may include, but is not limited to, having telemetry, tracking, and command, as well as communication capabilities (such as, for example and not limitation, a software defined radio), including an ability to communicate with other smallsat that work in unison with the first smallsat, effectively create what is generally referred to as a “swarm.” Since likely used in outer space, the smallsat architecture 1300 may also include an ability to track star locations via one or more image sensors. A flight computer 1315 may also be provided. The flight computer 1315 may include encryption capabilities to protect the smallsat and swarm from being taken over by an unauthorized user. Since the swarm may be established to work autonomously, based on a preset mission where decision making may occur based on information sharing and data processing of information, integration with an artificial intelligence subsystem 1320 may be provided that may include integrated cybersecurity and that may be designed for on orbit information sharing, decision making, and RPO. The architecture 1300 may also comprise one or more reaction wheels 1325. In some non-limiting exemplary embodiments, the reaction wheels 1325 may comprise a low-cost configuration, such as by being in-house. The embodiment shown in FIG. 13 is just an initial embodiment as other renditions are possible utilizing the embodiments disclosed herein.

Referring now to FIG. 14, a block diagram of an exemplary computer system, device, or computing functionality, 1400 useful for implementing various aspects of the processes disclosed herein, in accordance with one or more embodiments is shown. The computing device may be part hardware or equipment used to provide for the pattern to be moved cyclically in a constant and continuous pattern. In a basic configuration, a computing device 1400 may include any type of stationary computing device or a mobile computing device. The computing device may include one or more processors 1406 and system memory 1410 in a hard drive, or media device, 1408. The computing device may also comprise an AI component, as disclosed herein. Depending on the exact configuration and type of computing device, system memory 1410 may be volatile (such as RAM), non-volatile (such as read only memory (ROM), flash memory, and the like) or some combination of the two. A system memory 1410 may store an operating system, one or more applications, and may include program data for performing flight, navigation, avionics, power managements operations such as for space operations.

The computing device 1400 may carry out one or more blocks of a process described herein. The computing device may also have additional features or functionality. As a non-limiting example, the computing device may also include additional data storage devices (removable and/or non-removable) such as, for example, magnetic disks, optical disks, or tape. The computer storage media may include volatile and non-volatile, non-transitory, removable and non-removable media implemented in any method or technology for storage of data, such as computer readable instructions, data structures, program modules or other data. The system memory, removable storage and non-removable storage are all non-limiting examples of computer storage media. The computer storage media may include, but is not limited to, RAM, ROM, Electrically Erasable Read-Only Memory (EEPROM), flash memory or other memory technology, compact-disc-read-only memory (CD-ROM), digital versatile disks (DVD) or other optical storage, magnetic cassettes, magnetic tape, magnetic disk storage or other magnetic storage devices, or any other physical medium which can be used to store the desired data, and which can be accessed by computing device. Any such computer storage media may be part of device.

The computing device may also include or have interfaces 1412 for input device(s) 1414 (not shown) such as a keyboard, mouse, pen, voice input device, touch input device, etc. The computing device 1400 may include or have interfaces for connection to output device(s) such as a display, speakers, etc. The computing device may include a peripheral bus for connecting to peripherals. The computing device 1400 may also connect to a presentation module 1416 and a graphical user interface 1418. Computing device 1400 may contain communication connection(s) 1422 that allow the device to communicate with other computing devices, such as over a network or a wireless network via a network interface 1420. By way of example, and not limitation, communication connection(s) may include wired media such as a wired network or direct-wired connection, and wireless media such as acoustic, radio frequency (RF), infrared and other wireless media. The computing device may include a network interface card to connect (wired or wireless) to a network.

Computer program code for carrying out operations described above may be written in a variety of programming languages, including but not limited to a high-level programming language, such as C or C++, for development convenience. In addition, computer program code for carrying out operations of embodiments described herein may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed Digital Signal Processor (DSP) or microcontroller. A code in which a program of the embodiments is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD).

The embodiments may be configured for use in a computer or a data processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general-purpose computer, but rather the special purpose computer programmed to perform the disclosed algorithm.

A general-purpose computer, or microprocessor, may be programmed to carry out the algorithm/steps for creating a new machine. The general-purpose computer becomes a special purpose computer once it is programmed to perform particular functions pursuant to instructions from program software of the embodiments described herein. The instructions of the software program that carry out the algorithm/steps electrically change the general-purpose computer by creating electrical paths within the device. These electrical paths create a special purpose machine for carrying out particular algorithm/steps.

Unless otherwise defined, all terms (including technical and scientific terms) used herein have the same meaning as commonly understood by one of ordinary skill in the art to which embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In particular, unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such data storage, transmission or display devices.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

We claim:

1. A system for producing a modular bus architecture for use in a satellite, comprising:
a processor configurable to determine a build of the modular bus architecture based on pre-set parameters, to determine:
a support structure arrangement selected from predefined support structure components that are configurable to form various modular bus architectures for use in outer space where the support structure is configurable in a plurality of arrangements as determined by an intended space-based mission by the processor; and
components that are included with the support structure as determined by the processor based on parameters selected for an intended mission.

2. The system of claim 1, wherein the processor comprises at least one preprogrammed algorithm.

3. The system of claim 2, wherein the at least one preprogrammed algorithm comprises at least one machine learning algorithm.

4. The system of claim 1, wherein the processor comprises an artificial intelligence (“AI”) subsystem.

5. The system of claim 1, wherein the satellite is part of a swarm of same satellites.

6. The system of claim 1, wherein the support structure comprises one or more electronic components.

7. A method for producing a modular bus architecture for use in a satellite, comprising:
determining a build of the modular bus architecture based on pre-set parameters that are provided to a processor, further comprising:
arranging a support structure selected from predefined support structure components that are configurable to form various modular bus architectures for use in outer space where the support structure is configurable in a plurality of arrangements as determined by an intended space-based mission by the processor; and
selecting components that are included with the support structure as determined by the processor based on parameters selected for an intended mission.

8. The method of claim 7, wherein the satellite is part of a swarm of same satellites.

9. The method of claim 8, wherein subsequent satellites that are part of the swarm comprise the same parameters.

10. The method of claim 7, wherein the processor comprises at least one preprogrammed algorithm.

11. The method of claim 10, wherein the at least one preprogrammed algorithm comprises at least one machine learning algorithm.

12. The system of claim 7, wherein the processor comprises an artificial intelligence (“AI”) subsystem.

13. The method of claim 7, wherein the support structure comprises one or more electronic components.

14. The method of claim 7, further comprising:
manufacturing at least a portion of the support structure via an automated manufacturing process.

15. The method of claim 14, wherein the automated manufacturing process at least partially comprises additive manufacturing.

16. A satellite that is part of a swarm of satellites, the satellite comprising:
a support structure formed from a set of predefined support structures that are configurable to form the support structure for an intended mission of the satellite; and
a plurality of components included with the support structure, wherein the plurality of components are selected by a processor;
wherein the resulting satellite build is repeatable so that each satellite in the swarm is identical as established by the processor.

17. The satellite of claim 14, wherein the processor comprises at least one preprogrammed algorithm.

18. The satellite of claim 15, wherein the at least one preprogrammed algorithm comprises at least one machine learning algorithm.

19. The satellite of claim 14, wherein the processor comprises an artificial intelligence (“AI”) subsystem.

20. The satellite of claim 14, wherein the support structure comprises one or more electronic components.
